(19) United States
(12) Patent Application Publication
(10) Pub. No.: US 2011/0023051 A1
(43) Pub. Date: Jan. 27, 2011

(54) PROCESS MANAGEMENT SYSTEM AND METHOD

(75) Inventors: JYH-GWO JU, Tu-Cheng (TW); LIANG-MAO HUNG, Tu-Cheng (TW); TENG-YU TSAI, Tu-Cheng (TW); CHIA-PENG WANG, Tu-Cheng (TW); CHIA-HUNG CHIEN, Tu-Cheng (TW); CHIH-YUAN CHUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/610,385

(22) Filed: Nov. 2, 2009

(30) Foreign Application Priority Data
Jul. 24, 2009 (CN) 200910304766.8

(51) Int. Cl. G06F 3/048; G06F 9/46

(52) U.S. Cl. 719/313; 715/781

(57) ABSTRACT

A process management system includes a display, a process handling module and a plurality of window process modules communicating with the process handling module. Each window process module processes one function on the display. The process handling module stops an executing window process module before the process handling module starts another window process module.

### BACKGROUND

1. Technical Field

The present disclosure relates to a process management system and a process management method.

2. Description of Related Art

Embedded devices, for example, digital photo frames (DPFs) are becoming increasingly popular due to their convenience and ease of manipulation when implementing particular functions. However, if the embedded device has only one window application, all window functions (for example, video, photo) are integrated in the window application. Every time a user needs a window function (for example, browsing photos), the window application plus all other window functions is started up. This is a waste of system resources.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a process management system.

FIG. 2 is a schematic view of the process management system.

FIG. 3 is a flowchart of a process management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

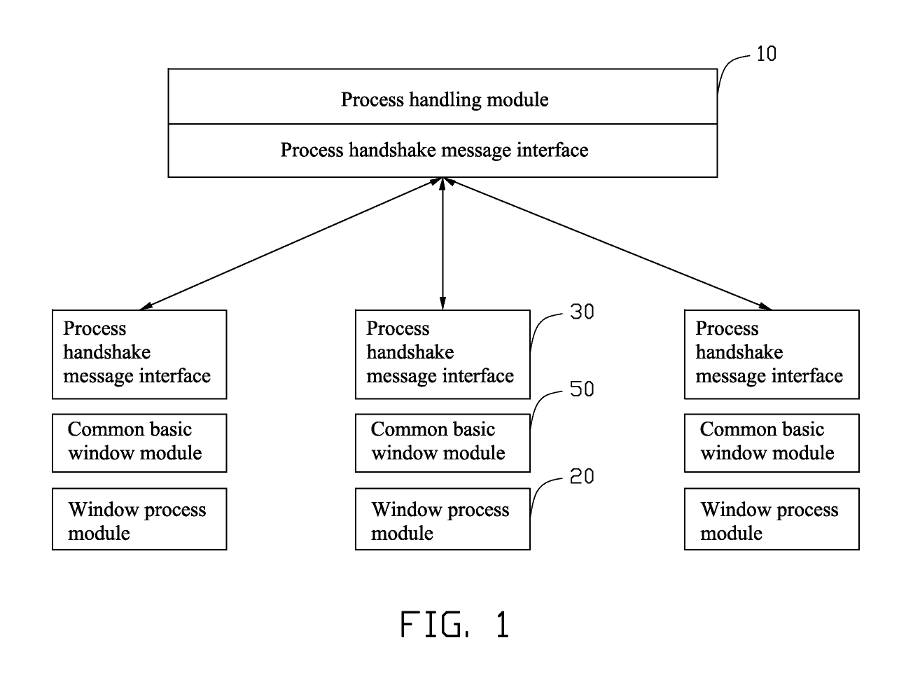

Referring to FIG. 1, a process management system includes a process handling module 10, a plurality of window process modules 20, and a display for showing each window process module 20. The process handling module 10 has a process handshake message interface 30 to communicate with the window process module 20 based on a unified standardized protocol.

The window process module 20 communicates with the process handling module 10 through the process handshake message interface 30 and a common basic window module 50. The common basic window module 20 provides a common basic function for the window process module 20. The window process module 20 may be a video window module, a photo window module, a radio window module.

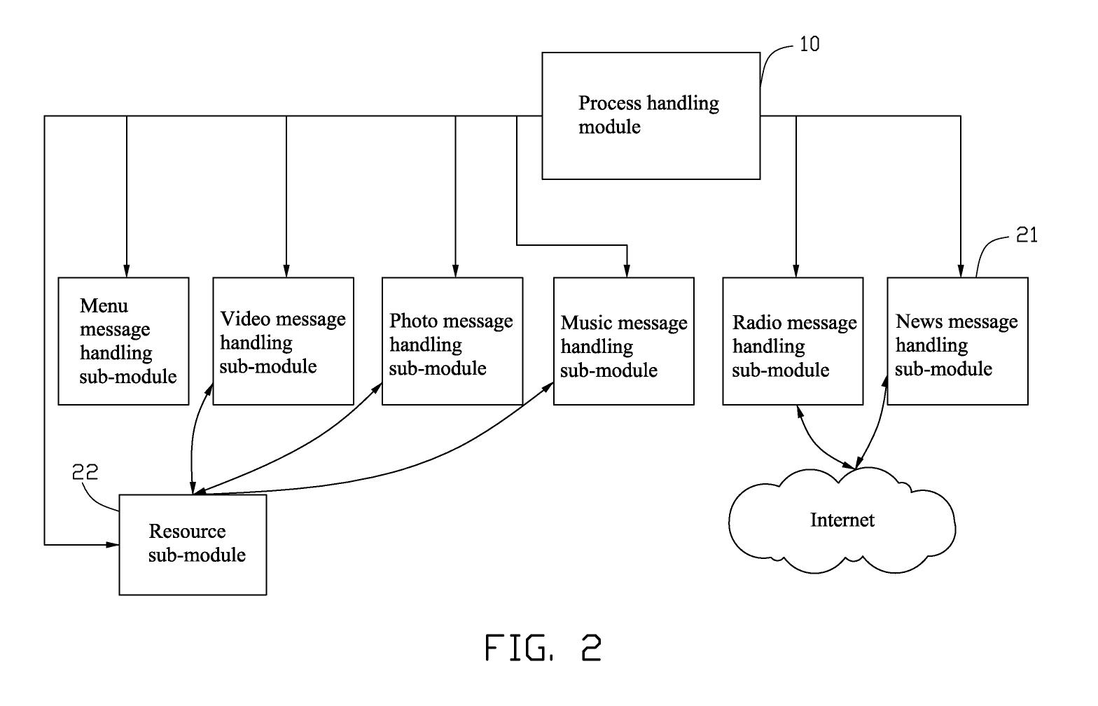

Referring to FIG. 2, the window process module 20 includes a message handling sub-module 21 and a resource sub-module 22. The message handling sub-module 21 receives messages from the process handling module 10 and connects to the resource sub-module 22 for retrieving resources. The process handling module 10 communicates with the window process module 20 in a unified message format using a message pipe.

The message handling sub-module 21 may be a video sub-module, a photo sub-module, a radio sub-module, and so on. The resource sub-module 22 may be a video resource, a photo resource, an Internet radio resource, and so on.

The process handling module 10 starts up the window process module 20. The process handling module 10 sends a check message to the window process module 20 to determine if the window process module 20 runs correctly. The window process module 20 sends an ok response message to the process handling module 10. When the window process module 20 runs correctly, the resources from the resource sub-module 22 show on the display.

The window process module 20 can send a terminate message to the process handling module 10. When it does, the process handling module 10 sends a stop response message to the window process module 20 to stop the window process module 20. Then the process handling module 10 can start another window process module 20.

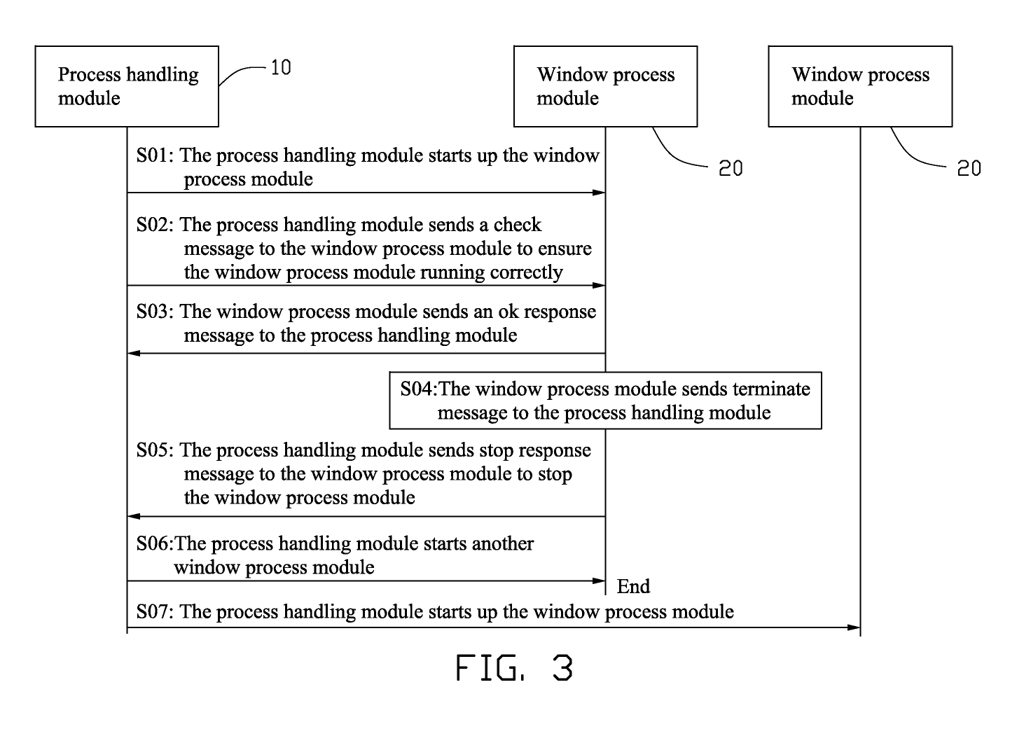

FIG. 3 is a flowchart illustrating one embodiment of a process management method. According to the embodiment, additional blocks in the flowchart of FIG. 3 may be added, others removed, and the ordering of the blocks may be changed.

In block S01, the process handling module 10 starts up the window process module 20.

In block S02, the process handling module 10 sends a check message to the window process module 20 to ensure the window process module 20 is running correctly.

In block S03, the window process module 20 sends an ok response message to the process handling module 10.

In block S04, the window process module 20 sends a terminate message to the process handling module 10.

In block S05, the process handling module 10 sends a stop response message to the window process module 20 to stop the window process module 20.

In block S06, the process handling module 10 starts another window process module 20.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A process management system, comprising:
a display;
a process handling module; and
a plurality of window process modules communicating with the process handling module, each window process module being capable of processing one function on the display;
wherein the process handling module stops an executing window process module before the process handling module starting another window process module.

2. The process management system of claim 1, wherein the process handling module communicates with the window process module via a message pipe.

3. The process management system of claim 2, wherein the process handling module is capable of communicating with the window process module in a unified message format by the message pipe.

4. The process management system of claim 3, wherein the process handling module comprises a process handshake message interface to communicate with the window process module.

5. The process management system of claim 4, wherein the process handshake message interface communicates with the window process module by a standardized protocol.

6. The process management system of claim 1, wherein the process management system further comprises a common basic window module to provide a common basic function for the window process module.

7. The process management system of claim 1, wherein the process handling module is capable of sending a check message to the window process module to determine if the window process module runs correctly.

8. The process management system of claim 1, wherein the window process module is capable of sending a terminate message to the process handling module to close the window process module.

9. The process management system of claim 1, wherein the window process module is a multimedia player module.

10. The process management system of claim 1, wherein the window process module is a network window module.

11. A process management method, comprising:
a process handling module starting up a window process module;
showing the window process module to process one function on a display;
the process handling module stopping the window process module before the process handling module starting another window process module.

12. The process management method of claim 11, wherein the process handling module communicates with the window process module by a message pipe.

13. The process management method of claim 12, wherein the process handling module communicates with the window process module in a unified message format by the message pipe.

14. The process management method of claim 13, wherein the process handling module comprises a process handshake message interface to communicate with the window process module.

15. The process management method of claim 14, wherein the process handshake message interface communicates with the window process module by a standardized protocol.

16. The process management method of claim 11, wherein a common basic window module provides a common basic function for the window process module.

17. The process management method of claim 11, wherein the process handling module sends a check message to the window process module to ensure the window process module running correctly.

18. The process management method of claim 11, wherein the window process module sends a terminate message to the process handling module to stop the window process module.

19. The process management method of claim 11, wherein the window process module is a multimedia player module.

20. The process management method of claim 11, wherein the window process module is a network window module.
